(19) United States
(12) Patent Application Publication
(10) Pub. No.: US 2007/0032139 A1
(43) Pub. Date: Feb. 8, 2007

(54) Electric device heat-sensitive sleeve structure

(76) Inventor: Min Li Chen, Linkou Industrial Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/492,863

(22) Filed: Jul. 26, 2006

(30) Foreign Application Priority Data
Jul. 29, 2005 (TW) 94212945

(51) Int. Cl. H01R 4/10

(52) U.S. Cl. 439/877

(57) ABSTRACT

An electric device heat-sensitive sleeve structure comprises an electric device. The electric device further includes a power conducting element and a power-sensitive sleeve. The power conducting element is used to conduct power. The heat-sensitive sleeve is disposed on the power conducting element, and contains heat-sensitive material. The heat-sensitive sleeve can detect temperature variation of the electric device through the heat-sensitive material. Timely detection can be accomplished when the electric device generates a large amount of heat. Therefore, the operator or management can take corresponding measures in real time to avoid unexpected sparking and power failure due to overheat of the electric device during power transmission, thereby ensuring normal and safe use of the electric device.

### BACKGROUND OF THE INVENTION

1. Field of the Invention

The present invention relates to an electric device heat-sensitive sleeve structure and, more particularly, to an electric device heat-sensitive sleeve structure capable of allowing a power transmission component of an electric device to detect the temperature timely so as to have the visual early-warning effect of avoiding a too high temperature of the electric device, thereby ensuring the safety in power transmission of the electric device.

2. Description of Related Technique

With continual development of the scientific industry, the power distribution application has become widespread. The electric power operation of large-scale buildings and factory buildings and the use of general electric equipments make electric power closely linked with people and also cause electric hazards to emerge in an endless stream. Electric power equipments installed in common buildings or factory buildings, regardless of being used as power transmission buses, power control boxes or switch boxes, have many power transmission components such as power conducting elements or power lines. If these power conducting elements are not properly connected or have other abnormal problems, the heating phenomenon due to power transmission will happen on these equipments. If this problem is not solved promptly, continual heating of the electric power equipments will lead to hazards such as sparking or power failure or even cause serious loss. For this safety misgiving in power usage of factory buildings or general electric appliances, there is no appropriate technique yet except the reinforcement in the safety examination and management measures of the factory buildings or electric appliances. The safety examination and management measures, however, are tedious and expensive, not conforming to the economic benefit of the factory building safety management. Moreover, they cannot render safe protection to the usage of electric devices (electric appliances).

In consideration of the above problems in the safe usage of electric device power conducting elements, the present invention aims to propose an electric device heat-sensitive sleeve structure of higher economy and safety, which can detect the situation when the electric device has a high temperature during power transmission. The operator, management or user can therefore easily take appropriate measures timely to solve these problems so as to ensure the safety in power transmission.

### SUMMARY OF THE INVENTION

An object of the present invention is to provide an electric device heat-sensitive sleeve structure, which can detect high heat generated during the power usage of an electric device timely so that the operator, management or user can take appropriate measures promptly to avoid hazards such as sparking and power failure.

Another object of the present invention is to provide an electric device heat-sensitive sleeve structure, which can enhance the safety in power transmission of an electric device in a more economic and effective way.

Another object of the present invention is to provide an electric device heat-sensitive sleeve structure, which lets a power conducting element of an electric device detect its high temperature state to accomplish very good protection in temperature measurement.

To achieve the above objects, the present invention provides an electric device heat-sensitive sleeve structure, which comprises an electric device. The electric device further includes a power conducting element and a power-sensitive sleeve. The power conducting element is used to conduct power. The heat-sensitive sleeve is disposed on the power conducting element, and contains heat-sensitive material. The heat-sensitive sleeve can detect temperature variation of the electric device through the heat-sensitive material.

### BRIEF DESCRIPTION OF THE DRAWINGS

The various objects and advantages of the present invention will be more readily understood from the following detailed description when read in conjunction with the appended drawing, in which:

FIG. 1 is an exploded perspective view of the present invention;

FIG. 2 is an assembly view of the present invention;

FIG. 3 is an assembly view of the power conducting element according to another embodiment of the present invention;

FIG. 4 is a cross-sectional view of the heat-sensitive sleeve of the present invention;

FIG. 5 is an application diagram of the present invention;

FIG. 6 is an application diagram of the heat-sensitive sleeve according to another embodiment of the present invention;

FIG. 6a is an application diagram of the heat-sensitive sleeve according to yet another embodiment of the present invention;

FIG. 7 is an application diagram of the heat-sensitive sleeve according to still yet another embodiment of the present invention; and

FIG. 8 is a cross-sectional view of the heat-sensitive sleeve shown in FIG. 7.

### DETAILED DESCRIPTION OF THE PREFERRED EMBODIMENTS

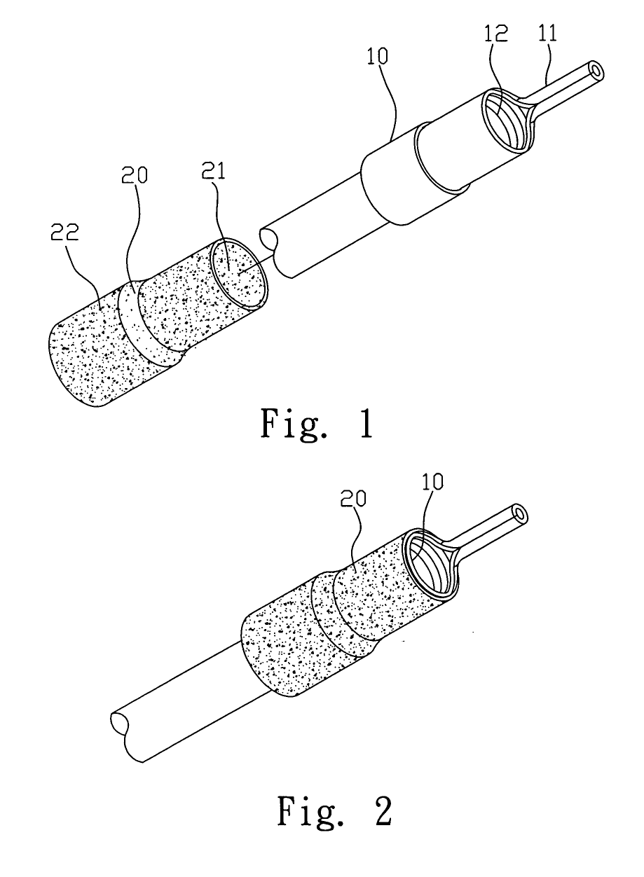

Electric devices of the present invention include buses for power transmission and control, electric boxes, switch boxes and general electric appliances. Their power conducting elements or power lines for power conduction and transmission are the improved target of the present invention. As shown in FIGS. 1 and 2, the present invention comprises a power conducting element 10 and a heat-sensitive sleeve 20. The power conducting element 10 is a metal sleeve body, and has a conducting end 11 and an accommodating room 12. The conducting end 11 is used to facilitate mating with other power conducting elements. The accommodating room 12 is used to facilitate fastening with other power connection ends, and is usually connected to a power line. The heat-sensitive sleeve 20 is disposed on the power conducting element 10. The heat-sensitive sleeve 20 is an insulating sleeve body, and has a sleeve space 21. The power conducting element 10 is sleeved in the sleeve space 21. Of course, the heat-sensitive sleeve 20 can also be sleeved on the power conducting element 10 by means of injection molding. The heat-sensitive sleeve 20 contains heat-sensitive material 22. The heat-sensitive sleeve 20 can generate color variation through the detection of temperature variation by the heat-sensitive material 22.

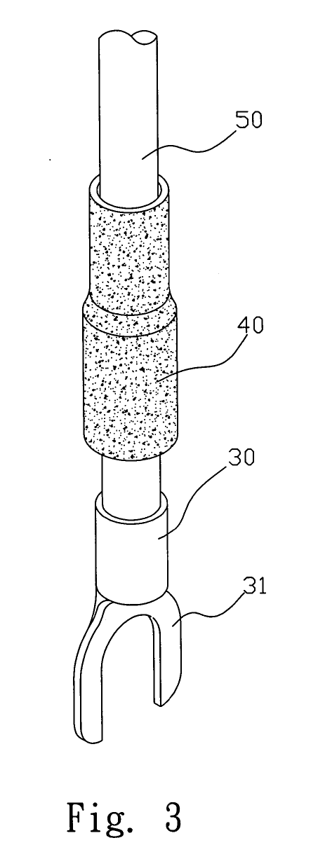

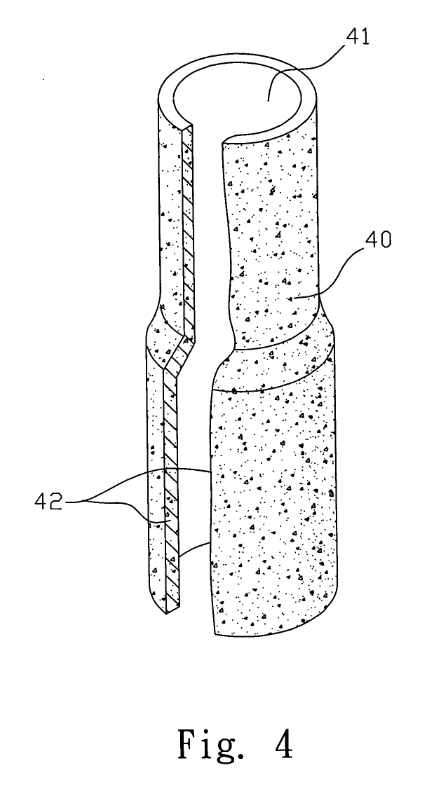

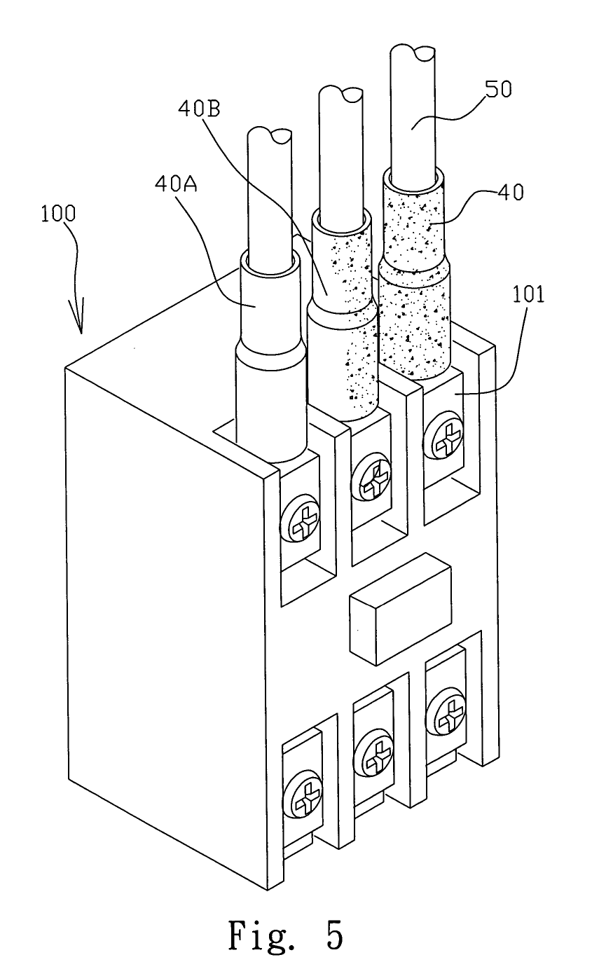

As shown in FIGS. 3, 4 and 5, a heat-sensitive sleeve 40 is disposed on a power conducting element 30. One end of the power conducting element 30 has a U-shaped conducting end 31 for power conduction and transmission. The other end of the power conducting element 30 is connected to a power line 50. The heat-sensitive sleeve 40 is an insulating sleeve body, and has a sleeve space 41. The power conducting element 30 is sleeved in the sleeve space 41. The heat-sensitive sleeve 40 can also be sleeved on the power conducting element 30 by means of injection molding. The heat-sensitive sleeve 40 contains heat-sensitive material 42. As shown in FIG. 5, the power conducting element 30 is connected to a power connection end 101 of an electric device 100. When the electric device 100 has an abnormal situation during power transmission or is used for a long time to cause a rise in temperature, the heat-sensitive sleeve 40 can generate color variation through the detection of temperature variation by the heat-sensitive material 42. For example, the heat-sensitive sleeve 40 is an opaque colored body under regular temperatures. When the heat-sensitive material 42 generate color variation under high temperatures, the heat-sensitive sleeve 40 will become transparent (e.g., the heat-sensitive sleeves 40A and 40B shown in FIG. 5). From the color variation of the appearance of the heat-sensitive sleeve 40, one can determine whether the electric device 100 (or other electric devices) is under a high-temperature load state. The operator or management can therefore take appropriate measures to avoid hazards such as sparking or power failure due to a too-hot load.

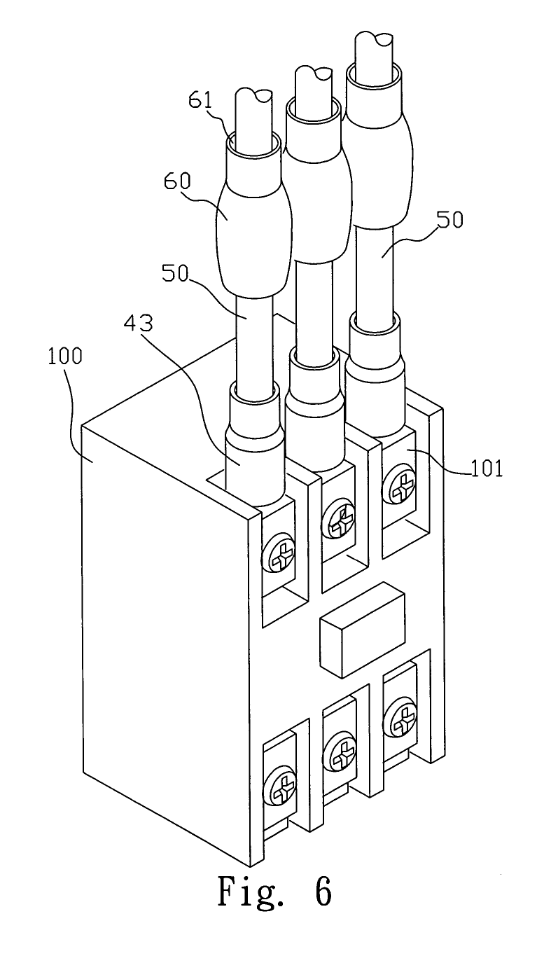

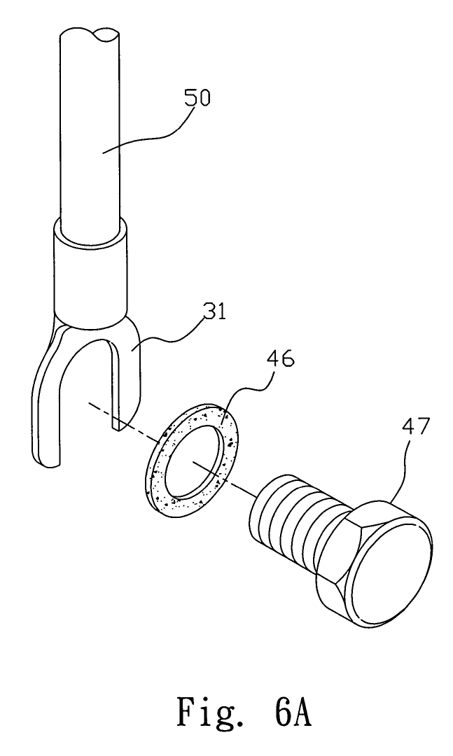

As shown in FIG. 6, a power conducting element 43 is connected to a power connection end 101 of an electric device 100, and is also connected to a power line 50. A heat-sensitive sleeve 60 is an insulating sleeve body, and has a sleeve space 61.The power line 50 or the power conducting element 43 is sleeved in the sleeve space 61. The heat-sensitive sleeve 60 contains heat-sensitive material. The heat-sensitive sleeve 60 can generate color variation through the detection of temperature variation by the heat-sensitive material. As shown in FIG. 6A, a heat-sensitive sleeve 46 is disposed between a conducting end 31 of the power conducting element 43 and a screw bolt 47 for fastening. The heat-sensitive sleeve 46 is similar to a washer, and can sleeved on the screw bolt 47. The heat-sensitive sleeve 46 contains heat-sensitive material, or has a heat-sensitive layer (e.g., a heat-sensitive paint contains heat-sensitive material) disposed thereon. The heat-sensitive sleeve 46 can generate color variation through the detection of temperature variation by the heat-sensitive material.

All the above power conducting element, power line or screw bolt can be generally called as a power guide that is used to conduct power. The heat-sensitive sleeve is sleeved on the power guide to detect abnormal rise of temperature of the power guide during power transmission, thereby accomplishing safe protection.

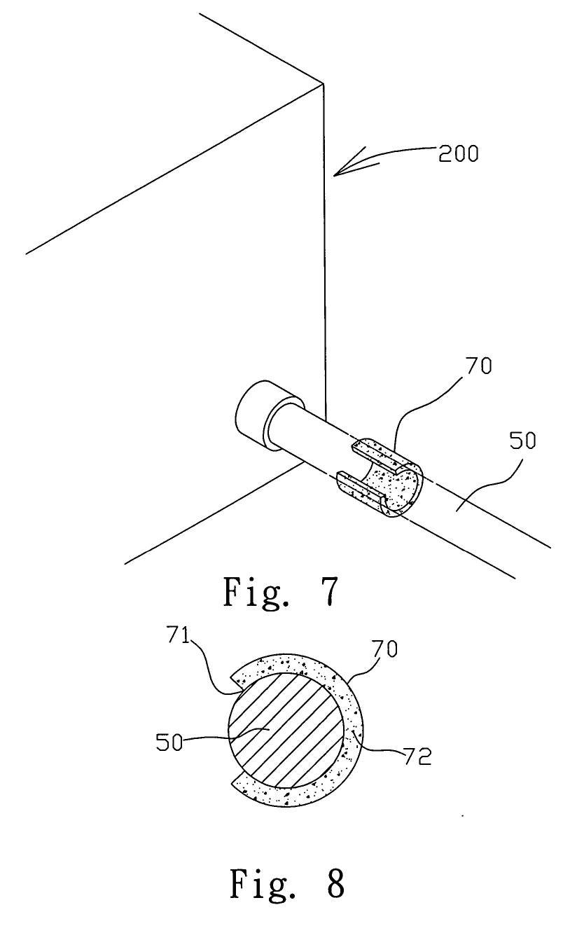

As shown in FIGS. 7 and 8, an electric device 200 is connected to a power line 50. An heat-sensitive sleeve 70 is a C-shaped insulating sleeve body, and has a gap portion 71. The heat-sensitive sleeve 70 can be conveniently sleeved on the power line 50 through the help of the gap portion 71. The heat-sensitive sleeve 70 contains heat-sensitive material. The heat-sensitive sleeve 70 can generate color variation through the detection of temperature variation by the heat-sensitive material. From the color variation of the appearance of the heat-sensitive sleeve 70, one can determine whether the electric device 200 is under a high-temperature load state. The operator or management can therefore take appropriate measures to avoid hazards such as sparking or power failure due to a too-hot load.

To sum up, in the electric device heat-sensitive sleeve structure of the present invention, a heat sleeve is sleeved on a power conducting element or a power line of an electric device. Through the help of the visible color variation of the appearance of the heat-sensitive sleeve, real-time early warning effect can be achieved, hence rendering protection to the usage of the electric device. Moreover, the setup of the heat-sensitive sleeve is very convenient, and has high economy and practicability.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An electric device heat-sensitive sleeve structure comprising an electric device, said electric device further comprising:
a power guide for conducting power; and
a heat-sensitive sleeve disposed on said power guide, said heat-sensitive sleeve containing heat-sensitive material, said heat-sensitive sleeve being capable of detecting the temperature variation phenomenon of said electric device through said heat-sensitive material.

2. The electric device heat-sensitive sleeve structure as claimed in claim 1, wherein said power guide is a power conducting element.

3. The electric device heat-sensitive sleeve structure as claimed in claim 2, wherein said power conducting element is a metal sleeve body.

4. The electric device heat-sensitive sleeve structure as claimed in claim 1, wherein said power guide is a power line.

5. The electric device heat-sensitive sleeve structure as claimed in claim 2, wherein said power conducting element comprises a conducting end and an accommodating room.

6. The electric device heat-sensitive sleeve structure as claimed in claim 1, wherein said heat-sensitive sleeve can be sleeved on said power guide by means of injection molding.

7. The electric device heat-sensitive sleeve structure as claimed in claim 1, wherein said heat-sensitive sleeve is an insulating sleeve body and has a sleeve space.

8. The electric device heat-sensitive sleeve structure as claimed in claim 1, wherein said heat-sensitive sleeve has a gap portion.

9. The electric device heat-sensitive sleeve structure as claimed in claim 1, wherein said power guide is a screw bolt, and said heat-sensitive sleeve is sleeved onto said screw bolt in a way like a washer.

10. The electric device heat-sensitive sleeve structure as claimed in claim 9, wherein a heat-sensitive layer is disposed on said heat-sensitive sleeve.
